(19) United States
(12) Patent Application Publication
(10) Pub. No.: US 2020/0210730 A1
(43) Pub. Date: Jul. 2, 2020

(54) VEHICLE EXTERIOR ENVIRONMENT RECOGNITION APPARATUS

(71) Applicant: SUBARU CORPORATION, Tokyo (JP)

(72) Inventor: Toshimi OKUBO, Tokyo (JP)

(21) Appl. No.: 16/658,974

(22) Filed: Oct. 21, 2019

(30) Foreign Application Priority Data
Dec. 27, 2018 (JP) 2018-244863

(51) Int. Cl. G06K 9/00; H04N 5/235; G06T 7/55

(52) U.S. Cl. CPC G06K 9/00825; H04N 5/2353; G06T 2207/30252; G06T 2207/10144; G06T 2207/20221; G06T 7/55

(57) ABSTRACT

A vehicle exterior environment recognition apparatus includes first and second luminance image acquiring units, first and second distance image generators, a region identifier, and a composite image generator. The region identifier is configured to identify a light source region in which a light source is present, on the basis of any of first luminance images acquired by the first luminance image acquiring unit at a first exposure time and any of second luminance images acquired by the second luminance image acquiring unit at a second exposure time shorter than the first exposure time. The composite image generator is configured to combine an image corresponding to the light source region in a second distance image generated by the second distance image generator and an image corresponding to a region excluding the light source region in a first distance image generated by the first distance image generator, and generate a composite image.

### CROSS-REFERENCE TO RELATED APPLICATIONS

The present application claims priority from Japanese Patent Application No. 2018-244863 filed on Dec. 27, 2018, the entire contents of which are hereby incorporated by reference.

### BACKGROUND

The technology relates to a vehicle exterior environment recognition apparatus that identifies a three-dimensional object.

A technique is known that detects a three-dimensional object, such as a vehicle, positioned ahead of an own vehicle. Such a technique detects the three-dimensional object to perform a collision avoidance control that avoids a collision with a preceding vehicle or an oncoming vehicle, or an adaptive cruise control that controls the own vehicle to keep a safe distance between the own vehicle and the preceding vehicle. For example, reference is made to Japanese Patent No. 3349060.

### SUMMARY

An aspect of the technology provides a vehicle exterior environment recognition apparatus that includes a first luminance image acquiring unit, a second luminance image acquiring unit, a first distance image generator, a second distance image generator, a region identifier, and a composite image generator. The first luminance image acquiring unit is configured to acquire a plurality of first luminance images captured at a predetermined first exposure time by a plurality of imaging units. The imaging units are positioned at locations different from each other. The second luminance image acquiring unit is configured to acquire a plurality of second luminance images captured at a second exposure time by the plurality of imaging units. The second exposure time is shorter than the first exposure time. The first distance image generator is configured to perform pattern matching on the plurality of first luminance images and generate a first distance image. The second distance image generator is configured to perform pattern matching on the plurality of second luminance images and generate a second distance image. The region identifier is configured to identify a light source region in which a light source is present, on the basis of any of the first luminance images and any of the second luminance images. The composite image generator is configured to combine an image corresponding to the light source region in the second distance image and an image corresponding to a region excluding the light source region in the first distance image, and generate a composite image.

An aspect of the technology provides a vehicle exterior environment recognition apparatus that includes circuitry configured to: acquire a plurality of first luminance images captured at a predetermined first exposure time by a plurality of imaging units, in which the imaging units are positioned at locations different from each other; acquire a plurality of second luminance images captured at a second exposure time by the plurality of imaging units, in which the second exposure time is shorter than the first exposure time; generate a first distance image by performing pattern matching on the plurality of first luminance images; generate a second distance image by performing pattern matching on the plurality of second luminance images; identify a light source region in which a light source is present, on the basis of any of the first luminance images and any of the second luminance images; and generate a composite image by combining an image corresponding to the light source region in the second distance image and an image corresponding to a region excluding the light source region in the first distance image.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a relationship of connection in a vehicle exterior environment recognition system according to one example embodiment of the technology.

FIG. 2 is a block diagram schematically illustrating operations of a vehicle exterior environment recognition apparatus according to one example embodiment of the technology.

FIG. 3 is a flowchart illustrating an example of a flow of a vehicle exterior environment recognition process according to one example embodiment of the technology.

FIGS. 4A and 4B are explanatory diagrams each illustrating an example of a first luminance image.

FIGS. 5A and 5B are explanatory diagrams each illustrating an example of a second luminance image.

FIGS. 6A to 6C are explanatory diagrams each illustrating an example of a method of generating a first distance image.

FIGS. 7A to 7C are explanatory diagrams each illustrating an example of a method of generating a second distance image.

FIGS. 8A and 8B are explanatory diagrams for describing an example of a light source region.

FIGS. 9A to 9C are explanatory diagrams for describing an example of a composite image.

FIGS. 10A and 10B are explanatory diagrams each illustrating an example of a process to be performed by a three-dimensional object identifier.

FIGS. 11A and 11B are explanatory diagrams each illustrating an example of a process to be performed by the three-dimensional object identifier.

### DETAILED DESCRIPTION

In the following, some embodiments of the technology are described in detail with reference to the accompanying drawings. Note that the following description is directed to illustrative examples of the disclosure and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the technology are unillustrated in the drawings.

To perform a collision avoidance control or an adaptive cruise control, it is necessary to recognize a vehicle exterior environment ahead of an own vehicle and identify, for example, whether a three-dimensional object present on an oncoming lane is a specific object such as an oncoming vehicle. However, in a situation where an imaging unit is provided inside the own vehicle and a windshield of the own vehicle is soiled, light also scatters around a high-luminance light source, such as headlights of the oncoming vehicle, in an image captured by the imaging unit, generating an unintended portion having a high luminance. Such a high-luminance portion can cause mismatching and lead to a noise in a distance image, which in turn makes the oncoming vehicle difficult to detect stably.

At least one embodiment aims to provide a vehicle exterior environment recognition apparatus that makes it possible to identify an oncoming vehicle stably.

[Vehicle Exterior Environment Recognition System 100]

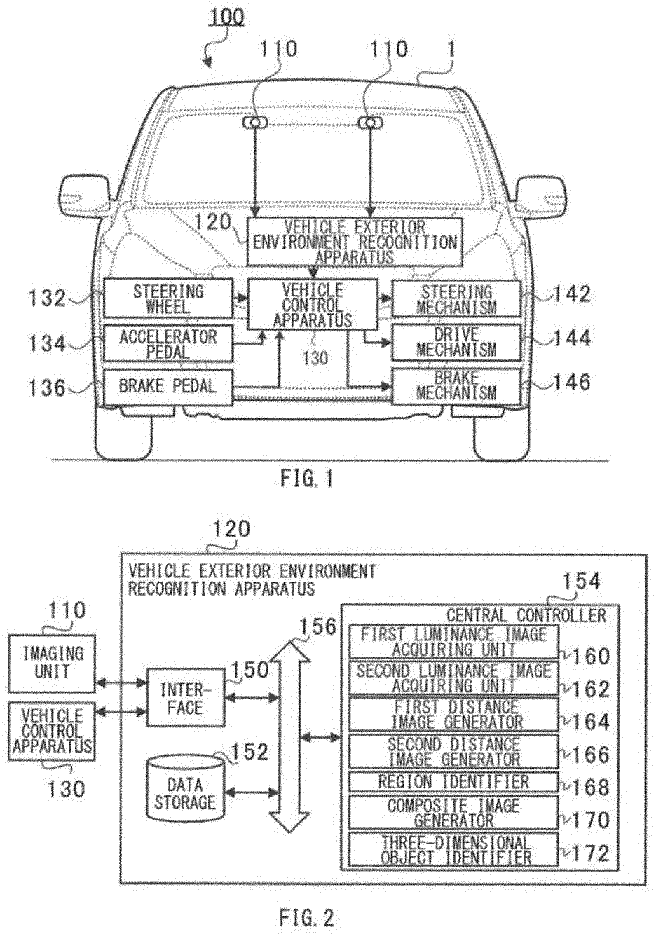

FIG. 1 is a block diagram illustrating a relationship of connection in a vehicle exterior environment recognition system 100 according to an example embodiment. The vehicle exterior environment recognition system 100 may include imaging units 110, a vehicle exterior environment recognition apparatus 120, and a vehicle control apparatus 130. For example, the vehicle control apparatus 130 may be an engine control unit (ECU).

The imaging units 110 each may include an imaging device such as a charge-coupled device (CCD) or a complementary metal-oxide semiconductor (CMOS). The imaging units 110 each may capture an image of a vehicle exterior environment ahead of an own vehicle 1, and each may generate a luminance image that contains at least data on luminance. The luminance image may be a color image or a monochrome image. For example, the two imaging units 110 may be so disposed that their respective optical axes become substantially parallel to each other along a traveling direction of the own vehicle 1. In addition, the two imaging units 110 may be so disposed as to be separated away from each other in a substantially horizontal direction. An example embodiment illustrated in FIG. 2 may include two imaging units 110, although the number of imaging units 110 is not limited to two.

The imaging units 110 each may continuously generate the luminance image for each frame of, for example, 1/60 second (at a frame rate of 60 fps). The luminance image may be obtained as a result of imaging performed on a three-dimensional object present in a detection region ahead of the own vehicle 1. Note that the three-dimensional objects to be recognized by the imaging units 110 may include a three-dimensional object that is present independently and an object serving as a part of the independently-present three-dimensional object. Non-limiting examples of the independently-present three-dimensional object may include a bicycle, a pedestrian, a vehicle (such as a preceding vehicle or an oncoming vehicle), a traffic light, a road sign, a guardrail, and a building.

The vehicle exterior environment recognition apparatus 120 may obtain the luminance image from each of the imaging units 110. Further, the vehicle exterior environment recognition apparatus 120 may generate a distance image having parallax data with use of so-called pattern matching. The parallax data may include a parallax and an image position that indicates a position of any block in an image. The pattern matching and the distance image are described later in greater detail.

Further, the vehicle exterior environment recognition apparatus 120 may first identify a road surface with use of three-dimensional position data, and perform grouping of blocks as a three-dimensional object. The blocks to be subjected to the grouping are those that are positioned on the identified road surface, equal to each other in color value, and close to each other in the three-dimensional position data. The three-dimensional position data may relate to a position defined by three-dimensional space in real space, and include a relative distance relative to the own vehicle 1, and may be calculated on the basis of a luminance value (i.e., the color value) based on the luminance image and on the basis of the distance image. By grouping the blocks, the vehicle exterior environment recognition apparatus 120 may identify which specific object does the three-dimensional object in the detection region ahead of the own vehicle 1 correspond to. For example, the vehicle exterior environment recognition apparatus 120 may identify whether the three-dimensional object in the detection region is the preceding vehicle or the oncoming vehicle.

When the specific object is thus identified, the vehicle exterior environment recognition apparatus 120 may perform a collision avoidance control that avoids a collision with the specific object, or an adaptive cruise control that controls the own vehicle 1 to keep a safe distance between the own vehicle 1 and the preceding vehicle. Note that, in one example, the parallax data for each block in the distance image may be converted into the three-dimensional position data with use of a so-called stereo method to determine the relative distance described above. The stereo method is a method that determines, from a parallax of a three-dimensional object, the relative distance of the three-dimensional object relative to the imaging units 110 with use of a triangulation method. Such a technique that obtains the three-dimensional position data from the two-dimensional parallax data may sometimes be called a stereo matching.

The vehicle control apparatus 130 may receive an input of an operation performed by a driver via each of a steering wheel 132, an accelerator pedal 134, and a brake pedal 136. The vehicle control apparatus 130 may transmit data based on the driver's operation input to a steering mechanism 142, a drive mechanism 144, and a brake mechanism 146 and thereby control the own vehicle 1. Further, the vehicle control apparatus 130 may control the steering mechanism 142, the drive mechanism 144, and the brake mechanism 146 in accordance with instructions given from the vehicle exterior environment recognition apparatus 120.

As described previously, the vehicle exterior environment recognition system 100 may perform the stereo matching on the basis of the luminance image obtained from each of the imaging units 110 provided in the vehicle interior to identify, for example, a three-dimensional position of a three-dimensional object present on an oncoming lane, such as the oncoming vehicle. However, in a situation where a windshield of the own vehicle 1 is soiled, light scatters not only at headlights of the oncoming vehicle serving as light sources but also around the headlights, generating unintended portions each having a high luminance. In this case, mismatching can occur between the high-luminance portions that are originally not the same, i.e., originally different from each other between the right side and the left side. Such unintentionally-matched portions can lead to a noise in the distance image, making it difficult to detect the oncoming vehicle stably.

At least one embodiment aims to improve a method of generating the distance image and stably identify the oncoming vehicle accordingly.

[Vehicle Exterior Environment Recognition Apparatus 120]

FIG. 2 is a block diagram schematically illustrating operations of the vehicle exterior environment recognition apparatus 120. Referring to FIG. 2, the vehicle exterior environment recognition apparatus 120 includes a central controller 154. The vehicle exterior environment recognition apparatus 120 may also include an interface (I/F) 150 and a data storage 152.

The interface 150 may allow for a bidirectional exchange of data between the imaging units 110 and the vehicle control apparatus 130. The data storage 152 may be any storage such as a random-access memory (RAM), a flash memory, or a hard disk drive (HDD). The data storage 152 may hold varies pieces of data necessary for executing processes by respective parts provided in the central controller 154 described below.

The central controller 154 may be or may include a semiconductor integrated circuit. For example, the semiconductor integrated circuit may include a central processing unit (CPU), a read-only memory (ROM) that holds programs, etc., and the RAM that serves as a work area. The central controller 154 may control, via a system bus 156, parts including the interface 150 and the data storage 152. In an example embodiment, the central controller 154 may also serve as a first luminance image acquiring unit 160, a second luminance image acquiring unit 162, a first distance image generator 164, a second distance image generator 166, a region identifier 168, a composite image generator 170, and a three-dimensional object identifier 172. In one embodiment, the central controller 154 may serve as a “first luminance image acquiring unit”, a “second luminance image acquiring unit”, a “first distance image generator”, a “second distance image generator”, a “region identifier”, and a “composite image generator”. In one embodiment, the central controller 154 may serve as a “three-dimensional object identifier”. In the following, a description is given in detail, together with an operation of each part of the central controller 154, a vehicle exterior environment recognition process that includes generation of the distance image, i.e., a composite image, which is one of features according to an example embodiment.

[Vehicle Exterior Environment Recognition Process]

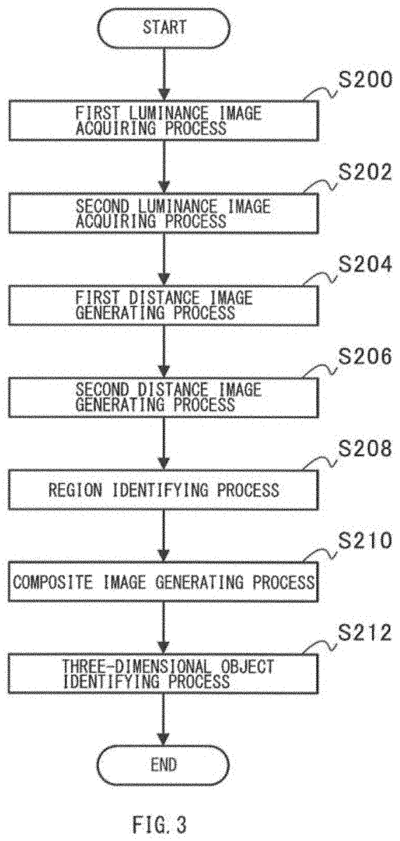

FIG. 3 is a flowchart illustrating an example of a flow of the vehicle exterior environment recognition process according to an example embodiment of the technology. The vehicle exterior environment recognition process may include a first luminance image acquiring process (step S200), a second luminance image acquiring process (step S202), a first distance image generating process (step S204), a second distance image generating process (step S206), a region identifying process (step S208), a composite image generating process (step S210), and a three-dimensional object identifying process (step S212) that are executed in this order at each predetermined interruption cycle. In the following, a description is given in detail of the processes.

[First Luminance Image Acquiring Process (Step S200)]

The first luminance image acquiring unit 160 may set an exposure time, i.e., a time during which the imaging device is exposed to light through a lens, of each of the imaging units 110 to a predetermined first exposure time or a “long exposure time”. The first luminance image acquiring unit 160 acquires a plurality of first luminance images captured at the first exposure time. In an example embodiment, the first luminance image acquiring unit 160 may acquire two first luminance images. The first exposure time may be a time of exposure that makes it possible to acquire an edge of a relatively dark portion in the vehicle exterior environment without causing underexposure of the relatively dark portion. For example, the relatively dark portion may be a specific object around the own vehicle 1 in the early evening or at night.

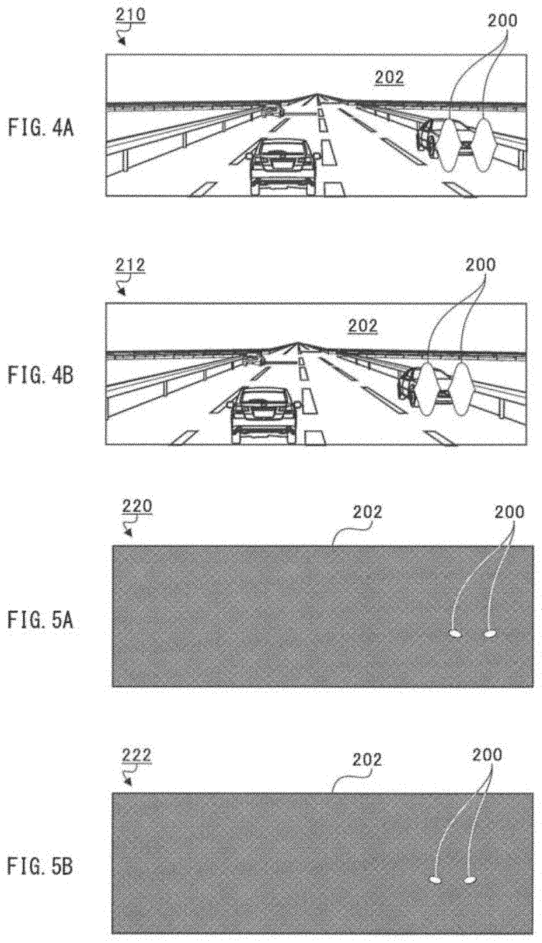

FIGS. 4A and 4B are explanatory diagrams each illustrating an example of the first luminance image. FIG. 4A illustrates a first luminance image 210 obtained by the imaging unit 110 disposed on the left side out of the imaging units 110 that are so disposed as to be separated away from each other in the substantially horizontal direction, whereas FIG. 4B illustrates a first luminance image 212 obtained by the imaging unit 110 disposed on the right side out of the imaging units 110. In an example illustrated in FIGS. 4A and 4B, imaging is performed at the relatively long exposure time in the early evening or at night. Thus, regions 200 in the vicinity of the respective headlights of the oncoming vehicle are overexposed. On the other hand, a specific object such as the preceding vehicle or a traffic light is acquired appropriately in a region 202 that is other than the oncoming vehicle.

[Second Luminance Image Acquiring Process (Step S202)]

The second luminance image acquiring unit 162 may set the exposure time of each of the imaging units 110 to a predetermined second exposure time or a “short exposure time”. The second luminance image acquiring unit 162 acquires a plurality of second luminance images captured at the second exposure time. In an example embodiment, the second luminance image acquiring unit 162 may acquire two second luminance images. The second exposure time may be a time of exposure that makes it possible to acquire an edge of a relatively light portion in the vehicle exterior environment without causing overexposure of the relatively light portion. Non-limiting examples of the relatively light portion may include the headlights and taillights. The second exposure time is shorter than the first exposure time in order to keep the exposure low. An interval between the imaging performed by the first luminance image acquiring unit 160 and the imaging performed by the second luminance image acquiring unit 162 may be set to an extremely short amount of time in order to secure simultaneity between the images.

FIGS. 5A and 5B are explanatory diagrams each illustrating an example of the second luminance image. FIG. 5A illustrates a second luminance image 220 obtained by the imaging unit 110 disposed on the left side out of the imaging units 110 that are so disposed as to be separated away from each other in the substantially horizontal direction, whereas FIG. 5B illustrates a second luminance image 222 obtained by the imaging unit 110 disposed on the right side out of the imaging units 110. In an example illustrated in FIGS. 5A and 5B, imaging is performed at the relatively short exposure time in the early evening or at night. Thus, the region 202 other than the oncoming vehicle is underexposed and the specific object such as the preceding vehicle is not clearly acquired accordingly. On the other hand, at least the headlights of the oncoming vehicle are acquired appropriately in the regions 200 in the vicinity of the respective headlights of the oncoming vehicle.

[First Distance Image Generating Process (Step S204)]

The first distance image generator 164 performs the pattern matching on the first luminance images 210 and 212 acquired by the first luminance image acquiring unit 160. By performing the pattern matching, the first distance image generator 164 generates a single first distance image. The first distance image may have the parallax data.

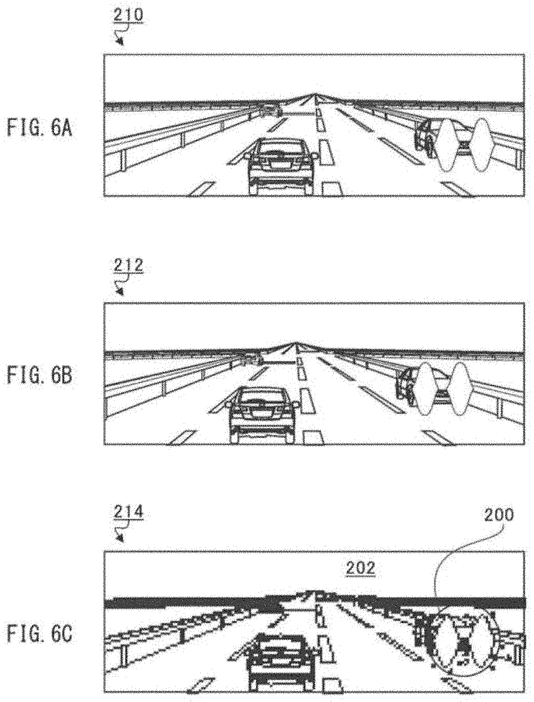

FIGS. 6A to 6C are explanatory diagrams each illustrating an example of a method of generating a first distance image 214. For example, the first distance image generator 164 may perform the pattern matching on the first luminance image 210 illustrated in FIG. 6A and the first luminance image 212 illustrated in FIG. 6B.

For example, the pattern matching may involve searching a block corresponding to any block extracted from one of the luminance images in the other of the luminance images, out of the first luminance images 210 and 212. Through performing the pattern matching, the parallax data may be calculated that includes the parallax and the image position that indicates a position of any block in an image. For example, the block may be an array of four horizontal pixels by four vertical pixels. The term “horizontal” refers to a lateral direction of the captured image, and the term “vertical” refers to a vertical direction of the captured image. To perform the pattern matching, a luminance (i.e., a Y color-difference signal) may be compared between the pair of luminance images on a block basis. Non-limiting examples of such a luminance comparison method may include SAD (Sum of Absolute Difference) that obtains luminance differences, SSD (Sum of Squared intensity Difference) that uses the squared differences, and NCC (Normalized Cross Correlation) that obtains similarity of variance obtained as a result of subtraction of an average luminance value from a luminance value of each pixel.

The vehicle exterior environment recognition apparatus 120 may perform the foregoing parallax deriving process, performed on a block basis, for all of the blocks in the detection region. For example, the detection region may be an array of 600 pixels by 200 pixels. In one example, each block may include the array of four pixels by four pixels; however, any number of pixels may be set for each block. Through performing the above example processes, the first distance image generator 164 may generate the first distance image 214 as illustrated in FIG. 6C.

It is to be noted that an image of the region 202 other than the oncoming vehicle is appropriately acquired in each of the first luminance images 210 and 212 respectively illustrated in FIGS. 6A and 6B. Accordingly, the parallax data of the region 202 other than the oncoming vehicle is appropriately calculated for the first distance image 214 illustrated in FIG. 6C as well. However, the light scatters to generate the unintended high-luminance portions in the regions 200 in the vicinity of the respective headlights of the oncoming vehicle in each of the first luminance images 210 and 212. The pattern matching based on such regions 200 can cause the mismatching between the high-luminance portions that are originally not the same, i.e., originally different from each other between the right side and the left side, which in turn decreases reliability in terms of distance.

[Second Distance Image Generating Process (Step S206)]

The second distance image generator 166 performs pattern matching on the second luminance images 220 and 222 acquired by the second luminance image acquiring unit 162. By performing the pattern matching, the second distance image generator 166 generates a single second distance image. The second distance image may have the parallax data.

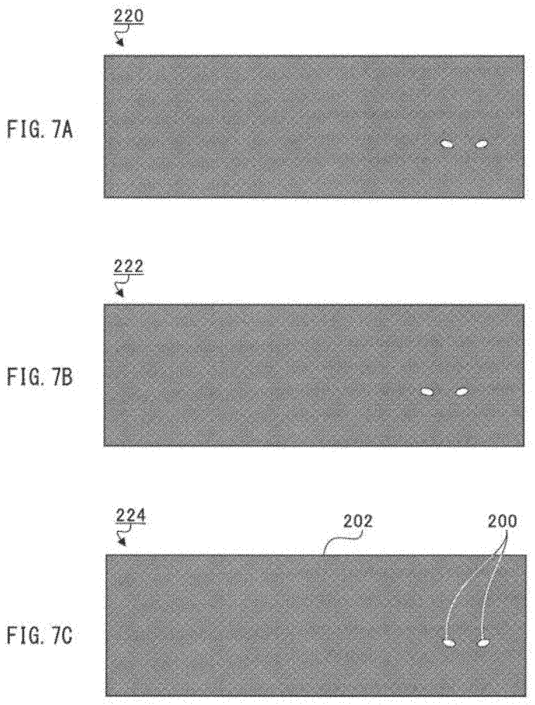

FIGS. 7A to 7C are explanatory diagrams each illustrating an example of a method of generating a second distance image 224. For example, the second distance image generator 166 may perform the pattern matching on the second luminance image 220 illustrated in FIG. 7A and the second luminance image 222 illustrated in FIG. 7B. As a result, the second distance image generator 166 may generate the second distance image 224 as illustrated in FIG. 7C.

It is to be noted that the regions 200 in the vicinity of the respective headlights of the oncoming vehicle are appropriately acquired in each of the second luminance images 220 and 222 respectively illustrated in FIGS. 7A and 7B. Accordingly, the parallax data of the headlights of the oncoming vehicle is appropriately calculated for the second distance image 224 illustrated in FIG. 7C as well. Note that the region 202 other than the oncoming vehicle is underexposed in each of the second luminance images 220 and 222. Accordingly, the pattern matching based on the region 202 is low in reliability in terms of distance.

[Region Identifying Process (Step S208)]

The region identifier 168 identifies a light source region in which the light source is present. For example, the region identifier 168 may identify the light source region in the second luminance image 220 in which the headlights of the oncoming vehicle are present.

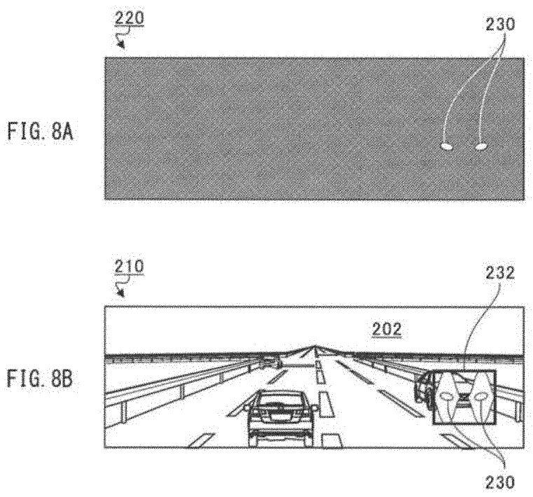

FIGS. 8A and 8B are explanatory diagrams for describing an example of a light source region 232. The light source region 232 includes the headlights 230 themselves (i.e., the light source itself). Accordingly, the region identifier 168 may first refer to the second luminance image 220 to appropriately identify the headlights 230 themselves as illustrated in FIG. 8A. The second luminance image 220 is short in exposure time and allows for identification of a high-luminance three-dimensional object. It is to be noted that referring to one of the second luminance images 220 and 222 suffices. Hence, the region identifier 168 in an alternative example embodiment may refer to the second luminance image 222 instead of the second luminance image 220.

It is to be also noted that a location, in which the light scatters to generate the unintended high-luminance portions and in which the mismatching can occur between the high-luminance portions, is around the headlights 230 and where the luminance is high. Such a location is more easily identified by the first luminance image 210 than the second luminance image 220 or 222. The first luminance image 210 is long in exposure time. Accordingly, in some embodiments, the region identifier 168 may identify a region that starts from positions of the respective headlights 230 of the oncoming vehicle in the second luminance image 220 and in which a luminance is equal to or greater than a predetermined luminance in the first luminance image 210, as denoted by a heavy black line in FIG. 8B. The region identifier 168 may determine the identified region as the light source region 232 as illustrated in FIG. 8B. For example, the predetermined luminance may be 250. It is to be noted that referring to one of the first luminance images 210 and 212 suffices. Hence, the region identifier 168 in an alternative example embodiment may refer to the first luminance image 212 instead of the first luminance image 210.

The thus-identified light source region 232 has features in which: (1) at least the headlights 230 are included; and (2) the unintentionally-matched portions tend to serve as a noise in the distance image upon generating the distance image, due to the light that scatters to generate the unintended high-luminance portions. Accordingly, the second distance image 224 that at least allows the headlights 230 to be appropriately identified may be used for the light source region 232 as described below, rather than using the first distance image 214 that tends to cause the mismatching.

The thus-identified light source region 232 is identified on the pixel basis, i.e., is based on a pixel. However, what is required here is a removal of a noise in the distance image, meaning that the light source region 232 is desirably identified on the block basis, i.e., identified on the basis of a block which is a target to be subjected to the pattern matching. Accordingly, the region identifier 168 may so expand the identified light source region 232 as to be based on and adapted to the block as the target to be subjected to the pattern matching, and may update the light source region 232.

In an example embodiment, the light source region 232 may have a contour that includes all of the blocks in which the luminance is equal to or greater than the predetermined luminance. The contour may be defined as a rectangular frame or a rectangular plane having two horizontal lines and two vertical lines as illustrated in FIG. 8B. A shape of the contour of the light source region 232, however, is not limited to the rectangular frame or the rectangular plane. In an alternative example embodiment, the contour of the light source region 232 may be set to have any of various shapes, such as a parallelogram, a trapezoid, a circle, or an ellipse.

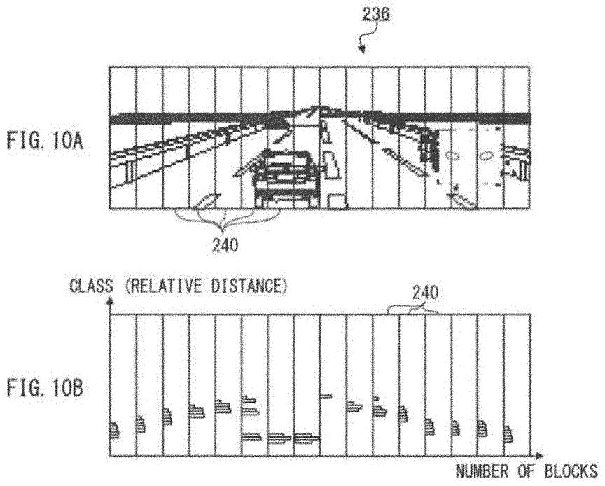

Further, in an example embodiment, the region in which the luminance is equal to or greater than the predetermined luminance (such as 250) in the first luminance image 210 may be identified in a horizontal direction and a vertical direction to set the light source region 232. However, the distance image, or a composite image 236 described below, may be determined on the basis of strip shapes that extend in the vertical direction as described later with reference to FIG. 10. Accordingly, the region identifier 168 may identify the region in which the luminance is equal to or greater than the predetermined luminance (such as 250) in the first luminance image 210 only in the horizontal direction to determine the light source region 232, in a situation where it is highly likely that a relative distance between the own vehicle 1 and the oncoming vehicle becomes the shortest. Identifying the region only in the horizontal direction in such a situation helps to reduce a processing load.

[Composite Image Generating Process (Step S210)]

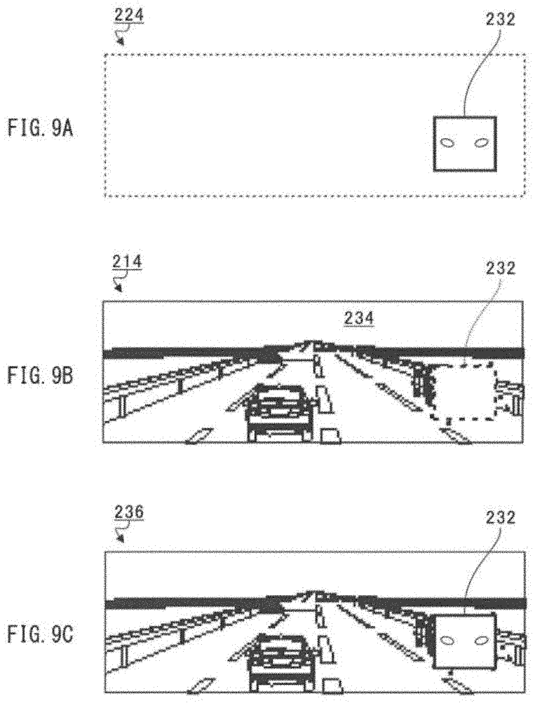

FIGS. 9A to 9C are explanatory diagrams for describing an example of the composite image 236. The composite image generator 170 combines an image corresponding to the light source region 232 in the second distance image 224 illustrated in FIG. 9A and an image corresponding to the region 234 excluding the light source region 232 in the first distance image 214 illustrated in FIG. 9B, and generates the composite image 236 as illustrated in FIG. 9C.

Thereafter, the composite image generator 170 may convert the parallax data corresponding to each of the blocks in the detection region in the composite image 236 into the three-dimensional position data with use of the stereo method. The three-dimensional position data may include pieces of data on a horizontal distance x, a height y, and a relative distance z.

The parallax data indicates the parallaxes of the respective blocks in the composite image 236, whereas the three-dimensional position data indicates data on the relative distances corresponding to the respective blocks in the real space. Further, in a case where the parallax data has been calculated on the block basis, i.e., on a plurality of pixel basis instead of a pixel basis, it is possible to regard such parallax data as parallax data that relates to all of the pixels belonging to any block to allow for a calculation on the pixel basis. For a conversion into such three-dimensional position data, any of various existing techniques, such as the technique disclosed in Japanese Unexamined Patent Application Publication No. 2013-109391, may be employed; accordingly, a description thereof will not be given in detail here.

[Three-Dimensional Object Identifying Process (Step S212)]

The three-dimensional object identifier 172 may identify a three-dimensional object on the basis of the composite image 236 generated by the composite image generator 170.

For example, the three-dimensional object identifier 172 may divide the composite image 236 into a plurality of divided regions, and generate a histogram (i.e., a frequency distribution) for each of the divided regions. The histogram includes the relative distances that correspond to the plurality of blocks in the corresponding divided region and are sorted on the basis of a plurality of classes. The plurality of classes is an arrangement, from shortest to longest, of distance segments of the relative distances classified at equal distances.

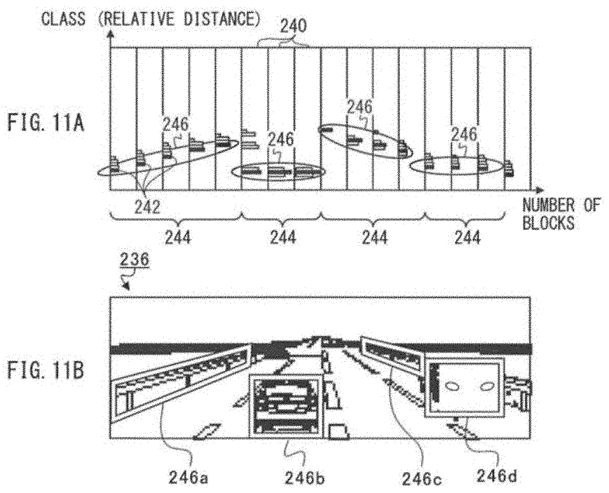

FIGS. 10A to 11B are explanatory diagrams each illustrating an example of a process to be performed by the three-dimensional object identifier 172. The three-dimensional object identifier 172 may first divide the composite image 236 into a plurality of divided regions 240 arrayed in a horizontal direction. Thus, the divided regions 240 each may have the strip shape extending in the vertical direction as illustrated in FIG. 10A. FIG. 10A illustrates an example in which the composite image 236 is equally divided into 16 regions as the strip-shaped divided regions 240 for description purpose. However, the composite image 236 may be divided into any number of regions. For example, the composite image 236 may be divided equally into 150 regions.

The three-dimensional object identifier 172 may thereafter determine, for all of the blocks that are regarded as being positioned on and above the road surface, which of the classes does the relative distance belong to in the corresponding divided region 240. The three-dimensional object identifier 172 may perform this determination on the basis of the three-dimensional position data and for each of the divided regions 240. Thereafter, the three-dimensional object identifier 172 may sort the relative distances into the corresponding classes to generate the histogram, as denoted by laterally-elongated quadrangles or bars in FIG. 10B. As a result, a distance distribution based on the histograms of each of the divided regions 240 is obtained as illustrated in FIG. 10B. In FIG. 10B, the vertical direction denotes the classes in which the relative distances are classified at equal distances, whereas the lateral direction denotes the number of blocks (i.e., frequency of blocks) sorted into the classes. Note that FIG. 10B illustrates a virtual screen directed to the calculation and no visual screen may be generated in practice.

Thereafter, the three-dimensional object identifier 172 may perform, in the composite image 236, grouping of the blocks in which their respective pieces of three-dimensional position data falls within a predetermined distance range. By performing the grouping, the three-dimensional object identifier 172 may identify a three-dimensional object. To identify the three-dimensional object, the three-dimensional object identifier 172 may first refer to the distance distribution corresponding to each of the divided regions 240, and determine the largest frequency (denoted by a black quadrangle in FIG. 11A) in each of the divided regions 240 as a representative distance 242.

The three-dimensional object identifier 172 may thereafter compare mutually-adjacent divided regions 240 with each other, and perform grouping of the divided regions 240 in which their respective representative distances 242 are close to each other (e.g., positioned within one meter or less with respect to each other). By performing the grouping, the three-dimensional object identifier 172 may generate one or more divided region groups 244 as illustrated in FIG. 11A. In a case where three or more divided regions 240 are close to each other in terms of their representative distances 242, the three-dimensional object identifier 172 may put all of such continuous divided regions 240 together as the divided region group 244. By performing the grouping, it is possible for the three-dimensional object identifier 172 to identify a size in a lateral width direction and a direction in a horizontal plane of any three-dimensional object positioned on and above the road surface.

The three-dimensional object identifier 172 may thereafter perform grouping of blocks in the divided region group 244, on the basis of a block, as the origin, in which the relative distance “z” is equivalent to the representative distance 242. For example, the three-dimensional object identifier 172 may perform the grouping of the originating block and any block in which differences each fall within a predetermined range from the originating block, on the assumption that those blocks correspond to the same specific object. The differences may include the difference in the horizontal distance “x”, the difference in height “y”, and the difference in the relative distance “z”, with respect to the originating block. The predetermined range may be ±0.1 meters, for example. Thus, a virtual block group may be generated. The above-described range may be expressed by a distance in real space, and may be set to any value by, for example, a manufacturer or a person riding on the vehicle. The three-dimensional object identifier 172 may further perform the grouping of any block newly added by the grouping as well, on the basis of the newly-added block as the origin. For example, the three-dimensional object identifier 172 may further perform the grouping of the originating newly-added block and any block in which the differences, including the difference in the horizontal distance x, the difference in height y, and the difference in the relative distance z, each fall within the predetermined range from the originating newly-added block. In other words, all of the groups assumable as the same specific object are grouped by the grouping.

Accordingly, the plurality of thus-grouped block groups may be extracted as illustrated in FIG. 11B. The three-dimensional object identifier 172 may identify a contour as a three-dimensional object 246 (e.g., three-dimensional objects 246a, 246b, 246c, and 246d). The contour may include all of the grouped blocks, and may be defined as a rectangular frame or a rectangular plane having horizontal lines and vertical lines, or having lines extending in a depth direction and the vertical lines. Thus, a size and a position of the three-dimensional object 246 may be identified.

The three-dimensional object identifier 172 may thereafter identify which of the specific objects does the grouped three-dimensional object 246 belongs to. For example, the three-dimensional object identifier 172 may determine the three-dimensional object 246 as the oncoming vehicle if a size, a shape, and a relative speed of that three-dimensional object 246 are likely equivalent to those of a vehicle, and if it is confirmed that the three-dimensional object 246 has the headlights, or light sources, at predetermined locations in front of the three-dimensional object 246.

The foregoing example embodiment performs the imaging of a combination of the plurality of distance images (two distance images in an example embodiment) at the exposure times that are different from each other, and performs the pattern matching at each of the exposure times to generate the distance images. Thereafter, the foregoing example embodiment combines the distance images on the basis of reliability, in terms of distance, as to whether the mismatching occurs easily, and generates the single composite image 236. Hence, it is possible to identify the oncoming vehicle stably.

At least one embodiment also provides a program that causes a computer to function as the vehicle exterior environment recognition apparatus 120, and a computer-readable recording medium that stores the program. Non-limiting examples of the recording medium may include a flexible disk, a magneto-optical disk, ROM, CD, DVD (Registered Trademark), and BD (Registered Trademark). As used herein, the term “program” may refer to a data processor written in any language and any description method.

Although some example embodiments of the technology have been described in the foregoing by way of example with reference to the accompanying drawings, the technology is by no means limited to the embodiments described above. It should be appreciated that modifications and alterations may be made by persons skilled in the art without departing from the scope as defined by the appended claims. The technology is intended to include such modifications and alterations in so far as they fall within the scope of the appended claims or the equivalents thereof.

For example, the foregoing example embodiment may perform the imaging at the exposure times that are different from each other, i.e., at the first exposure time and the second exposure time. In an alternative example embodiment, however, two luminance images may be generated at each of three or more exposure times, and the pattern matching may be performed on the generated luminance images to generate three or more distance images. Thereafter, the plurality of distance images may be combined on the basis of the reliability in terms of distance. Such a configuration makes it possible to divide the exposure times into fine segments and thereby achieve the distance images or the composite image having higher accuracy.

Further, in the foregoing example embodiment, the light source region may be a region in which the headlights of the oncoming vehicle are present. However, any light source suffices in the light source region. For example, in an alternative example embodiment, the light source region may be a region in which taillights and/or brake lights of the preceding vehicle are present.

A part or all of the processes performed by the central controller 154 in an example embodiment described above does not necessarily have to be processed on a time-series basis in the order described in the example flowchart illustrated in FIG. 3. A part or all of the processes performed by the central controller 154 may involve parallel processing or processing based on subroutine.

According to at least one embodiment, it is therefore possible to identify the oncoming vehicle stably.

The central controller 154 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the central controller 154. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the central controller 154 illustrated in FIG. 2.

1. A vehicle exterior environment recognition apparatus comprising:
a first luminance image acquiring unit configured to acquire a plurality of first luminance images captured at a predetermined first exposure time by a plurality of imaging units, the imaging units being positioned at locations different from each other;
a second luminance image acquiring unit configured to acquire a plurality of second luminance images captured at a second exposure time by the plurality of imaging units, the second exposure time being shorter than the first exposure time;
a first distance image generator configured to perform pattern matching on the plurality of first luminance images and generate a first distance image;
a second distance image generator configured to perform pattern matching on the plurality of second luminance images and generate a second distance image;
a region identifier configured to identify a light source region in which a light source is present, on a basis of any of the first luminance images and any of the second luminance images; and
a composite image generator configured to combine an image corresponding to the light source region in the second distance image and an image corresponding to a region excluding the light source region in the first distance image, and generate a composite image.

2. The vehicle exterior environment recognition apparatus according to claim 1, wherein the region identifier is configured to identify, as the light source region, a region that starts from a position of the light source in the any of the second luminance images and in which a luminance is equal to or greater than a predetermined luminance in the any of the first luminance images.

3. The vehicle exterior environment recognition apparatus according to claim 1, further comprising a three-dimensional object identifier configured to identify a three-dimensional object on a basis of the composite image generated by the composite image generator.

4. The vehicle exterior environment recognition apparatus according to claim 1, wherein the light source comprises a headlight of an oncoming vehicle.

5. A vehicle exterior environment recognition apparatus comprising
circuitry configured to
acquire a plurality of first luminance images captured at a predetermined first exposure time by a plurality of imaging units, the imaging units being positioned at locations different from each other,
acquire a plurality of second luminance images captured at a second exposure time by the plurality of imaging units, the second exposure time being shorter than the first exposure time,
generate a first distance image by performing pattern matching on the plurality of first luminance images,
generate a second distance image by performing pattern matching on the plurality of second luminance images,
identify a light source region in which a light source is present, on a basis of any of the first luminance images and any of the second luminance images, and
generate a composite image by combining an image corresponding to the light source region in the second distance image and an image corresponding to a region excluding the light source region in the first distance image.
